(19) United States
(12) Patent Application Publication
(10) Pub. No.: US 2012/0042193 A1
(43) Pub. Date: Feb. 16, 2012

(54) CLOCK FREQUENCY SELECTION SCHEME

(75) Inventors: Saurabh Gupta, Sunnyvale, CA (US); Robert Curtis, San Jose, CA (US); Tow Wang, Cupertino, CA (US); Anup Sharma, Sunnyvale, CA (US)

(73) Assignee: Apple Inc., Cupertino, CA (US)

(21) Appl. No.: 12/856,104

(22) Filed: Aug. 13, 2010

(51) Int. Cl. G06F 1/06

(52) U.S. Cl. 713/501

(57) ABSTRACT

Systems and methods for selecting and setting clock frequencies for an electronic device are disclosed. Specifically, clock frequencies may be adjusted to avoid interference with input electromagnetic energy, often in radio frequency bands. Clock frequencies may be chosen to minimize signal interference and improve device performance. In some embodiments, clock frequency information is stored in one or more lookup tables in device memory. In certain embodiments, a system processor can access the information stored in the lookup table and instruct system circuitry to adjust clock frequency as needed based on lookup table entries.

### FIELD OF THE DISCLOSED SUBJECT MATTER

This is directed to minimizing electromagnetic signal interference by selecting and adjusting clock frequencies for an electronic device based on an electromagnetic signal source.

### BACKGROUND OF THE DISCLOSURE

Many of today's electronic devices, and in particular portable electronic devices, have multiple functionalities. For example, current cellular telephones may provide a web browser for surfing the Internet and checking e-mail, a music player for playing MP3 files stored on the device, a camera for capturing pictures and videos, and a radio receiver for tuning to various radio stations in a geographic area. The functionality supported by such electronic devices continue to increase even though the devices themselves continue to shrink and become more portable. Many of these functions use wireless components that rely on electromagnetic (EM) signals. In particular, some EM signals can operate in radio frequency (“RF”) bands.

Consequently, electronic devices may not provide any electromagnetic shielding, or alternatively only provide limited electromagnetic shielding, for various electronic components within these devices. Limited or no shielding can result in interference among device components, which may result in decreased device performance.

### SUMMARY OF THE DISCLOSURE

Systems and methods are provided for minimizing electromagnetic (“EM”) signal interference by adjusting a clock frequency of one or more clocks based on a frequency of an EM signal source.

For example, an electronic device may not be able to clearly receive an FM radio station because of interference from one or more device clocks. Based on device requirements, one or more of these clock frequencies can be adjusted to improve FM station reception on the device.

In one embodiment, an electronic device can have one or more data structures such as, for example, lookup tables stored in device memory containing frequency information for one or more clocks of the device. The lookup table data structure can be an array stored in device memory, which can store data accessible by a device processor. Using a lookup table to store data can save processing power and time by reducing the number of calculations a processor has to make. A lookup table can specify which frequencies the one or more clocks should be set to, based on a frequency of the EM signal source. The EM signal source may come from a variety of sources including, for example, FM radio, AM radio, GSM signals, television signals, and Wi-Fi network signals.

A processor of the electronic device can receive input information related to the operating frequency of the EM signal source. Based on this input information, it can access operating frequency information stored in one or more lookup tables for one or more device clocks. In certain embodiments, the processor can compare lookup table data for multiple clocks and determine which of the clocks need to be adjusted. The processor can then select operating frequencies for one or more of the clocks to avoid interference from the EM signal source.

The processor may provide instructions to adjust the clock frequencies for any number of clocks. The clock frequencies can be selected to avoid interference with the input EM signal source, with other clocks, and/or with other device components.

Clock frequencies may be chosen based on these or other factors. In some embodiments, clock frequencies may be chosen to minimize interference not only from the center frequency but also from other frequency components of the input EM signal source. In other embodiments, clock frequencies may be selected to minimize interference from harmonics of any of these frequencies. For example, in certain embodiments, while energy from the center frequency of an EM signal may not cause interference with the clocks on the electronic device, the second, third, or even fourth harmonics of the center frequency may overlap with one or more clock frequencies of the electronic device. Such clock frequencies can therefore be selected for adjustment. Similarly, harmonics of the electronic device clock operating frequencies can interfere with proper operation of the electronic device (e.g., proper reception of the EM signal and/or proper operation of communications circuitry designed to use the input EM signal), which may also require one or more clock frequencies to be adjusted.

In yet another embodiment, an even finer degree of clock frequency selection can be implemented, particularly for the clock frequency provided to a canless RF module. In this embodiment, a lookup table may be provided that specifies whether a high-side or low-side of the clock frequency provided to the RF module should be selected. The high-side/low-side refers to the injection side frequency that is provided to a mixer (in the RF module) to produce an intermediate frequency that is further processed by other circuitry in the device.

### BRIEF DESCRIPTION OF THE DRAWINGS

The above and other aspects and advantages of the disclosed subject matter will be apparent upon consideration of the following detailed description, taken in conjunction with accompanying drawings, in which like reference characters refer to like parts throughout, and in which:

FIG. 1 is a schematic view of an illustrative electronic device that can contain systems for selecting clock frequencies based on an input EM signal according to an embodiment of the invention;

FIG. 2 is a schematic view of an illustrative system coupling clock frequency selection circuitry components to other electronic device component circuitry according to an embodiment of the invention;

FIG. 3 is a schematic view of a data structure that can be stored in memory containing frequency selection information for system clocks according to an embodiment of the invention; and

FIG. 4 is a flowchart of an illustrative process for selecting and adjusting clock frequencies based on an input EM signal according to an embodiment of the invention.

### DETAILED DESCRIPTION

Systems and methods are disclosed for selecting clock frequencies based on an EM signal received by a canless RF module.

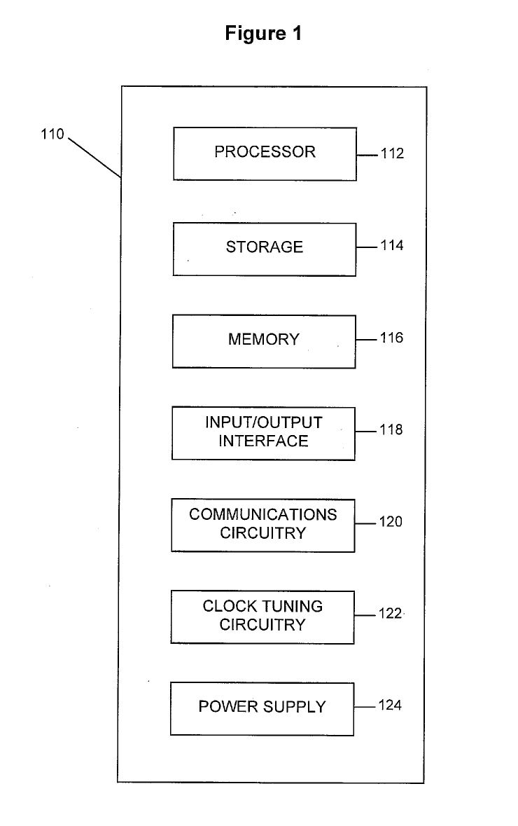

An electronic device used as part of the disclosed systems and methods can perform some or all of the features described above and can include any suitable combination of hardware, firmware and software for selecting clock frequencies. FIG. 1 is a schematic view of an illustrative electronic device that can contain a system for selecting clock frequencies based on an input EM signal.

Electronic device 110 can include any suitable type of electronic device operative to process media items. For example, electronic device 110 can include a media player such as an iPod® available by Apple Inc., of Cupertino, Calif., a cellular telephone, a personal e-mail or messaging device (e.g., a Blackberry® or a Sidekick®), an iPhone® available from Apple Inc., pocket-sized personal computers, personal digital assistants (PDAs), a laptop computer, a desktop computer, a music recorder, a video recorder, a camera, radios, medical equipment, and any other device capable of playing back media items.

Electronic device 110 may include processor 112, storage 114, memory 116, input/output interface 118, communications circuitry 120, clock tuning circuitry 122, and power supply 124. In some embodiments, one or more components of electronic device 110 may be combined or omitted (e.g., combine storage 114 and memory 116). In some embodiments, electronic device 110 may include other components not combined or included in those shown in FIG. 1 (e.g., location circuitry, sensing circuitry detecting the device environment or a bus), or several instances of the components shown in FIG. 1. For the sake of simplicity, only one of each of the components is shown in FIG. 1.

Processor 112 may include any processing circuitry or control circuitry operative to control the operations and performance of electronic device 110. For example, processor 112 may be used to run operating system applications, firmware applications, media playback applications, media editing applications, or any other application. In some embodiments, a processor may drive a display and process inputs received from a user interface. In certain embodiments, processor 112 may also be incorporated as part of a system-on-a-chip (SoC).

Storage 114 may include, for example, one or more storage mediums including a hard-drive, solid state drive, flash memory, permanent memory such as ROM, any other suitable type of storage component, or any combination thereof. Storage 114 may store, for example, media data (e.g., music and video files), application data (e.g., for implementing functions on device 110), firmware, user preference information (e.g., media playback preferences), authentication information (e.g. libraries of data associated with authorized users), lifestyle information (e.g., food preferences), exercise information (e.g., information obtained by exercise monitoring equipment), transaction information (e.g., information such as credit card information), wireless connection information (e.g., information that may enable electronic device 110 to establish a wireless connection), subscription information (e.g., information that keeps track of podcasts or television shows or other media a user subscribes to), contact information (e.g., telephone numbers and email addresses), calendar information, and any other suitable data or any combination thereof.

Memory 116 can include cache memory, semi-permanent memory such as RAM, and/or one or more different types of memory used for temporarily storing data. In some embodiments, memory 116 can also be used for storing data used to operate electronic device applications, or any other type of data that may be stored in storage 114. In some embodiments, memory 116 and storage 114 may be combined as a single storage medium.

Input/output interface 118 may provide inputs to input/output circuitry of the electronic device. Input/output interface 118 may include any suitable input interface, such as for example, a button, keypad, dial, a click wheel, or a touch screen. In some embodiments, electronic device 110 may include a capacitive sensing mechanism or a multi-touch capacitive sensing mechanism. In some embodiments, input interface can include a microphone or other audio input interface for receiving a user's voice inputs. The input interface can include an analog to digital converter for converting received analog signals corresponding to a voice input to a digital signal that can be processed and analyzed to identify specific words or instructions.

In some embodiments, input/output interface 118 can instead or in addition include one or more interfaces for providing an audio output, visual output, or other types of output (e.g., odor, taste or haptic output). For example, input/output interface 118 can include one or more speakers (e.g., mono or stereo speakers) built into electronic device 110, or an audio connector (e.g., an audio jack or an appropriate Bluetooth connection) operative to be coupled to an audio output mechanism. Input/output interface 118 may be operative to provide audio data using a wired or wireless connection to a headset, headphones or earbuds. As another example, input/output interface 118 can include display circuitry (e.g., a screen or projection system) for providing a display visible to the user. The display can include a screen (e.g., an LCD screen) that is incorporated in electronic device 110, a movable display or a projecting system for providing a display of content on a surface remote from electronic device 110 (e.g., a video projector), or any other suitable display. Input/output interface 118 can interface with the input/output circuitry (not shown) to provide outputs to a user of the device.

Communications circuitry 120 can be operative to create or connect to a communications network. Communications circuitry 120 can be capable of providing wireless communications using any suitable short-range or long-range communications protocol. For example, communications circuitry 120 can support Wi-Fi (e.g., a 802.11 protocol), Bluetooth (registered trademark), radio frequency systems (e.g., 1200 MHz, 2.4 GHz, and 5.6 GHz communication systems), infrared, protocols used by wireless and cellular phones and personal email devices, or any other protocol supporting wireless communications.

In some embodiments, communications circuitry 120 can receive radio signals (e.g., AM or FM radio signals) from an antenna configured to receive the signals. Communications circuitry 120 may include tuning components that can demodulate the radio signal and decompose the radio signal into a portion containing audio (e.g., music, talk shows, commercials, or interviews) and a portion containing embedded data (e.g., an RDS data packet). In certain embodiments, communications circuitry 120 can provide any portions of the radio signal containing embedded data to processor 112. Communications circuitry 120 may instead or in addition be capable of providing wired communications, for example using any suitable port on one or both of the devices (e.g., 30-pin, USB, FireWire, Serial, or Ethernet).

Clock tuning circuitry 122 can be configured to adjust or maintain clock frequency for any of the clocks on electronic device 110. In certain embodiments, clock tuning circuitry 122 may include the clocks themselves. Clock selection circuitry 122 may include oscillators or any other source that can reliably provide an accurate clock signal at a fixed or controllable frequency. Clock tuning circuitry 122 may also include one or more phase lock loops that can adjust clock circuit frequencies. Clock tuning circuitry 122 may additionally include frequency tuning circuitry that can set clock source and phase lock loop parameters as necessary to change or maintain clock operating frequencies based on, for example, instructions from processor 112.

Power supply 124 can include any suitable circuitry for receiving and/or generating power, and for providing such power to one or more components of electronic device 110. In some embodiments, power supply 124 can be coupled to a power grid (e.g., when device 110 is not acting as a portable device or when a power supply of the device is being charged at an electrical outlet with power generated by an electrical power plant). As another example, power supply 124 can be configured to generate power from a natural source (e.g., solar power using solar cells).

In some embodiments, electronic device 110 may include a bus (not shown in FIG. 1) operative to provide a data transfer path for transferring data to, from, or between control processor 112, storage 114, memory 116, input/output interface 118, communications circuitry 120, clock selection circuitry 122, power supply 124, and any other component(s) included in the electronic device.

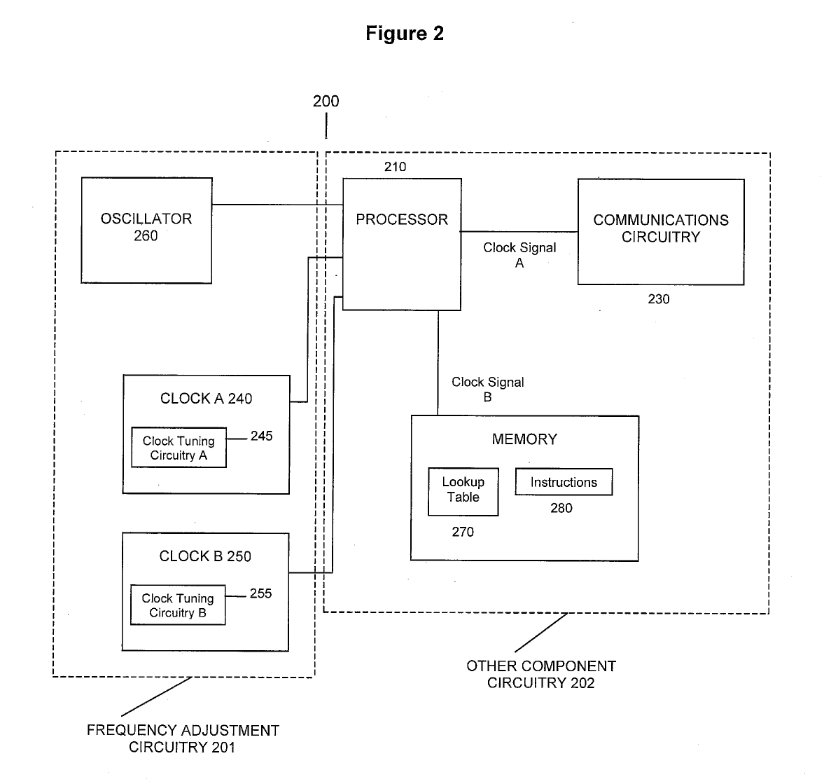

FIG. 2 is a schematic view of an illustrative system 200 coupling frequency adjustment circuitry 201 to other component circuitry 202 of an electronic device (e.g., electronic device 110 of FIG. 1).

The clock tuning circuitry components and other electronic device component circuitry may be similar to components described in FIG. 1. Similarly, system 200 may have any of the features and functionalities described above in connection with FIG. 1, and vice versa. System 200 may include a processor 210, memory 220, communications circuitry 230, clock A 240, clock B 250, clock tuning circuitry A 245, clock tuning circuitry B 255, oscillator 260, lookup table 270 and instructions 280. Further, system 200 may include several instances of certain components. For example, system 200 may include more than two clocks, each with its own associated circuitry. In some embodiments, one or more components of electronic device 200 may be combined or omitted. For example, as shown in FIG. 2, clock A may include clock tuning circuitry A 245 and be driven by oscillator 260. Similarly, clock B may include clock tuning circuitry B 255 and may also be driven by oscillator 260. Additionally, clock tuning circuitry may include phase lock loop (not shown) and oscillator components (e.g., oscillator 260). In certain embodiments, the clock tuning circuitry may be incorporated into the clocks (e.g., clock A 240 and clock B 250). In some embodiments, system 200 may include other components not combined or included in those shown in FIG. 2 (e.g., location circuitry or sensing circuitry used to detect the device environment), or several instances of the components shown in FIG. 2.

Communications circuitry 230 may receive an EM input data signal from a variety of sources. In some embodiments, the system can receive an RF radio signal, for example, in the form of an AM or FM radio broadcast. In other embodiments, the system may receive EM data signals in other forms such as, for example, Wi-Fi (e.g., a 802.11 protocol), Bluetooth (registered trademark), 900 MHz, 1.4 GHz, and 5.6 GHz communication systems, infrared, GSM, GSM plus EDGE, CDMA, quadband, and other cellular protocols, VoIP, or any other suitable protocol. It is understood that AM or FM radio signals are analog radio signals and are more susceptible to interference than their digital counterparts.

In certain embodiments, communication circuitry 230 may use a tuner designed to receive EM input signals (e.g., RF signals). The tuner may be enclosed in metal surroundings designed to eliminate or reduce crosstalk and other RF interference. These metal surroundings may provide shielding, sometimes referred to as a can. The shielding, however, requires the metal surrounding shielding, adding expense and weight.

Because shielded or canned tuners are often bulky and require significant board space, certain embodiments of communications circuitry 230 may use canless tuners instead. Canless tuners can be designed such that they are not enclosed in metal or other conductive surroundings (shields) and may be incorporated as part of an integrated circuit. Because of this, canless tuners can be significantly smaller than canned tuners while providing additional functionality. For example, a canless tuner can often be less expensive to manufacture, provide greater design flexibility, and importantly, take up less space on a board than a canned tuner designed to operate at similar frequencies.

Generally, canned tuners can be better isolated from other device components because of their metal surrounding. The metal surrounding of a canned tuner can act as an electrical shield, blocking the leakage of signals between the tuner and other device components.

Because canless tuners lack the metal surroundings associated with canned tuners, they are more susceptible to noise and interference problems, especially when surrounded by other device components operating over similar frequency ranges. This interference may be particularly severe when the operating frequency or associated harmonics of other device components are in the same frequency bands as the operating frequency of the canless tuner.

In certain embodiments, canless tuners receiving FM signals may be especially prone to noise from low-power FM signals. In particular, when the receiving circuitry is physically distant from the transmitting circuitry, which is often the case with portable devices, FM signals may be more prone to noise, thereby creating noise problems for the canless tuners.

In certain embodiments, clock A 240 may provide a clock signal for communications circuitry 230, and can oscillate, for example, at the carrier frequency of an input EM signal. Clock A 240 may be configured to provide clock signals that operate over a wide range of frequencies based on the frequency spectrum of the incoming EM data signal. Clock B 250 may provide a clock signal for any other suitable device components of an electronic device. For example, clock B 250 can be a clock signal that oscillates at the operating frequency of processor 210, clock tuning circuitry (e.g., clock tuning circuitry 245 and/or clock tuning circuitry 255), and/or any other suitable components (e.g., any suitable component of electronic device 100 of FIG. 1).

Both clock A 240 and clock B 250 can be constructed using phase lock loops that can provide clock signals for the electronic device. In certain embodiments, each clock may have its own unique phase lock loop. In other embodiments, the clocks may share one or more phase lock loops.

After communications circuitry 230 receives an input EM signal, it may then send either the received input EM signal or data extracted from the received input EM signal (e.g., center frequency, carrier frequency, frequency spectrum, and/or signal strength) to processor 210 for further processing. Processor 210 can use the data received from communications circuitry 230 to access data stored in one or more data structures (e.g., one or more lookup tables). In certain embodiments, data can be stored in lookup table 270 stored in memory 220. Persons skilled in the art will appreciate that although memory 220 can store more than one lookup table, only one lookup table is shown in FIG. 2.

In certain embodiments, system 200 can include multiple lookup tables, where each lookup table can store data corresponding to a different clock. In other embodiments, a single lookup table 270 can store clock frequencies for multiple clocks.

The stored clock frequencies may be selected to optimize device performance and minimize interference with other clocks and device components including communications circuitry 230. For example, in certain embodiments, clock frequencies may be chosen to minimize interference of communication circuitry 230 caused by clock operating frequencies and harmonic frequencies. Based on the frequency data stored in lookup table 270, processor 210 can select operating frequencies for both clock A 240 and clock B 250, which can be optimized for system design and performance requirements.

Processor 210 can also compare lookup table data for multiple clocks and compare the results between clocks to determine which clock frequency or frequencies need to be adjusted. Lookup table 270 may store data comparing noise levels and device performance results with different clock states. In particular, the stored lookup table data can take into account that the performance of a clock is affected by other device components and clocks.

For example, an electronic device may experience less noise with clock A 240's frequency adjusted while clock B 250's frequency remains the same, but it may be more power efficient for the device to switch clock B 250's frequency while keeping clock A 240 at the same frequency. As another example, operating each of clock A 240 or clock B 250 at a given frequency may impact the performance of the other clock. Lookup table 270 can store data related to device noise levels and device power usage results and processor 210 can compare this data for different clocks to determine which clock frequency or frequencies need to be adjusted.

Based on design, performance requirements and other considerations, memory 220 can also store instructions 280 for switching one or more clock frequencies based on the entries stored in lookup table 270. In certain embodiments, processor 210 can access instructions 280 and send them to one or both of clock tuning circuitry A 245 and clock tuning circuitry B 255 so that the frequencies of clock A 240 and clock B 250 can be adjusted accordingly.

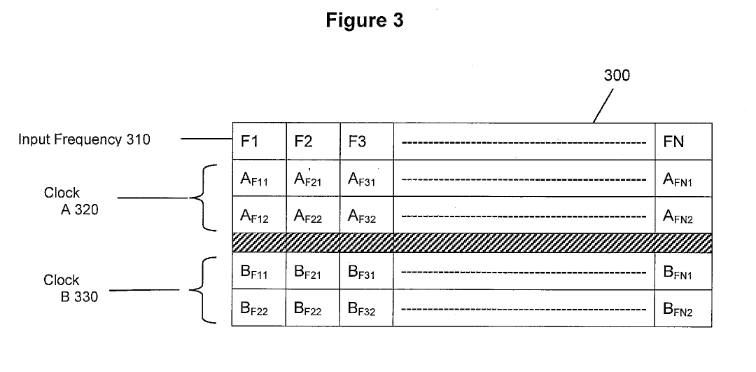

FIG. 3 is a schematic view of a data structure that can be stored in memory and can include operating frequency information for electronic device clocks (e.g., clock A 240 and clock B 250 of FIG. 2).

Lookup table 300 can store a variety of data associated with EM data received from communications circuitry 230 and device clock frequencies. Table 300 can include input frequency row 310, clock A operating frequency rows 320 and clock B operating frequency rows 330. The data stored in rows 320 and 330 may be similar to the data stored in lookup table 270 of FIG. 2 and can be used by a processor similar to processor 210 of FIG. 2 to select operating frequencies for any or all of the clocks in an electronic device. If a device has more than two clocks, table 300 may include additional rows that can store operating frequency data for some or all of these clocks. These additional rows may be similar to rows 320 and 330.

Input frequency row 310 can store a list of input frequencies which can correspond to the input frequency of an input EM signal that can be received by communications circuitry such as, for example, circuitry 120 of FIG. 1 or circuitry 230 of FIG. 2. Row 310 can list discrete input frequencies (e.g., 101.3 Mhz, 104.5 Mhz, etc.) or a ranges centered around each discrete input frequency (e.g., 101.25-101.35 Mhz) for input EM signals in a variety of data protocols. For example, row 310 may list a series of frequencies (F₁-F_{N}) corresponding to FM radio stations, AM radio stations, Wi-Fi signals, and cellular phone protocols. Each entry in rows 320 may list different operating frequencies for clock A (A_{row}_{_{—}}_{320,1}-A_{row}_{_{—}}_{320,N}), where the entries, A_{row}_{_{—}}_{320,1}-A_{row}_{_{—}}_{320,N}, are associated with frequencies F₁-F_{N} listed in row 310. Similarly, each entry in rows 330 may list different operating frequencies for clock B (B_{row}_{_{—}}_{330,1}-B_{row}_{_{—}}_{330,N}). In certain embodiments, each entry in rows 320 and 330 may correspond to an input frequency listed in row 310.

For example, row 310 may contain an entry associated with an input EM signal having a carrier frequency of 96.3 MHz. The entry may list, for example, the carrier frequency of the input EM signal (i.e., 96.3 MHz), the data protocol of the input EM signal, and the power level of the input EM signal. Rows 320 may contain entries associated with this same input EM signal and listing operating frequencies for clock A. Rows 330 may also contain entries associated with this same input EM signal and listing operating frequencies for clock B. For example, for an input EM signal having a carrier frequency of 96.3 MHz, rows 320 can list 440 MHz and 460 MHz as potential operating frequencies for clock A. For this same input EM signal, rows 330 can list 600 MHz and 620 MHz as potential operating frequencies for clock B.

In certain embodiments, the data stored in lookup table 300 can include lists of clock frequencies selected to minimize interference from the input EM signal and from other clocks. Clock frequencies may also be selected to prevent clock interference with communications circuitry and with the reception of an input EM signal.

The clock frequencies selected for entry in lookup table 300 may be chosen based on a number of factors. For example, the clock frequencies may be selected based on physical measurements made during electronic device design and testing. By using such measurements, the system can account for the effects that system components have on each other and select optimal clock frequencies based on “real-world” conditions. Measurements can be made to accurately reflect how system components behave with respect to various EM input signals, and clock frequencies can be adjusted during testing to determine optimal operating frequencies. As another example, optimal clock frequencies may also be selected based on computer simulations made during electronic device design and testing.

In certain embodiments, measurements can be made and simulations can be run with various system clocks turned on, off, or running at different frequencies and/or power levels. This can provide insights into how system components affect each other, and can provide greater flexibility in choosing clock frequencies to meet system requirements under various operating conditions and device configurations.

In some embodiments, lookup table entries in rows 320 and 330 may include estimates of system and component noise levels or scores evaluating signal quality for a given clock setting. In other embodiments, lookup table entries in rows 320 and 330 may include information regarding the “costs” of switching clock frequencies compared to the improvements in system performance and noise reduction.

In an exemplary embodiment, a processor similar to similar to processor 112 of FIG. 1 or processor 210 of FIG. 2 can access lookup table 300 and compares the table entries for clock A and clock B that are associated with a given EM input signal, it can compare this data to determine operating frequencies for each of the clocks.

For example, if clock A can operate at either frequency 1 or frequency 2 and clock B can operate at either frequency 3 or frequency 4, when the communications circuitry is tuned to a given frequency (e.g., 96.3 MHz), the lookup table can store data indicating that certain clock frequencies (e.g. frequencies 1 and 3) may lead to lower power consumption for an electronic device, while other clock frequencies, (e.g. frequencies 2 and 4) lower noise/interference levels for the device. Depending on device settings and requirements (which can be indicated in settings stored in memory similar to memory 116 of FIG. 1 or to memory 220 of FIG. 2), the processor can select clock operating frequencies accordingly. For example, if lower power consumption is desired, the processor can instruct clock A to operate and frequency 1 and clock B to operate at frequency 3. Similarly, if lower noise levels are desired, the processor can instruct clock A to operate and frequency 2 and clock B to operate at frequency 4.

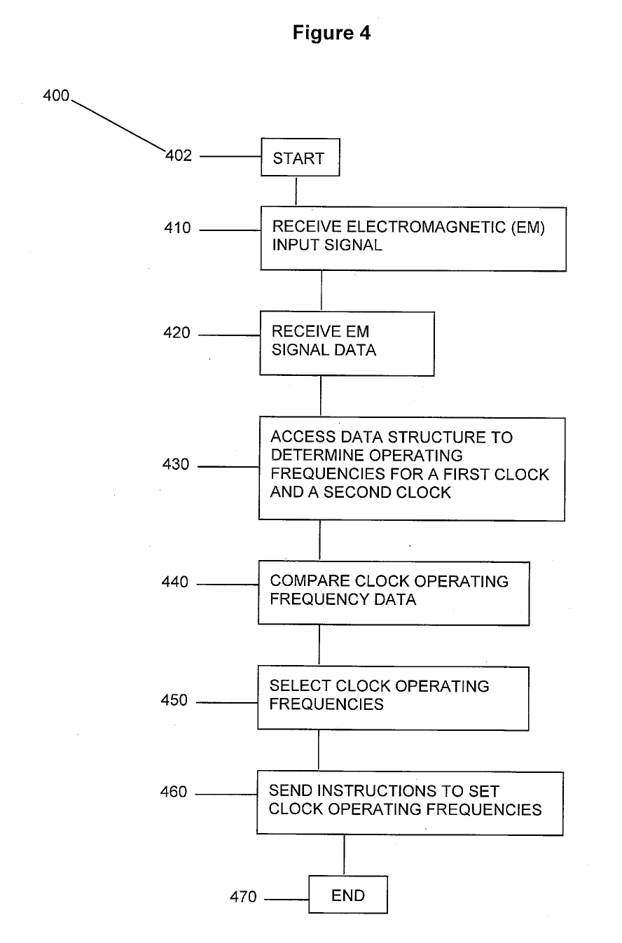

FIG. 4 is a flowchart of an illustrative process 400 for selecting and adjusting clock frequencies based on EM signal data.

Process 400 starts at block 402. At block 410, an EM input signal can be received. This step may be performed by communications circuitry (e.g., communications circuitry 120 of FIG. 1 or communications circuitry 230 of FIG. 2) that is tuned to an appropriate frequency. The received EM input signals can be in various protocols such as, for example, Wi-Fi (e.g., a 802.11 protocol), Bluetooth (registered trademark), 900 MHz, 1.4 GHz, and 5.6 GHz communication systems, infrared, GSM, GSM plus EDGE, CDMA, quadband, and other cellular protocols, VoIP, or any other suitable protocol, and FM and AM radio broadcasts.

At block 420, EM signal data is received. The EM signal data can be related to the input EM signal that can received by the communications circuitry. The EM signal data may be the same as the input EM signal originally received by the communications circuitry, or it may be data extracted from the input EM signal. For example, the extracted data can include information associated with the frequency, power spectrum, left or right channel information, or input signal bandwidth associated with the input EM signal. Based on this data, the tuned frequency of the input EM signal and any associated circuitry can be determined. In certain embodiments, this step can be performed by a processor similar to processor 112 of FIG. 1 or processor 210 of FIG. 2.

At block 430, a data structure can be accessed to determine operating frequencies for a first clock and a second clock. The data structure can be stored in device memory and may be in the form of a lookup table similar to lookup table 300 of FIG. 3. It may store data similar to data in rows 320 and 330 of FIG. 3. The device memory may be similar to memory 116 of FIG. 1 or memory 220 of FIG. 2. In some embodiments, based on EM signal data received in step 420, a processor can access data stored in at least one entry in the data structure. For example, in certain embodiments, if the EM signal data indicates an FM radio station carrier frequency (e.g., 96.3 MHz), the processor can use this data to access lookup table data corresponding to this FM radio station.

At block 440, clock operating frequency data for at least two different clocks can be compared. The clock operating frequency data can be stored in a lookup table similar to lookup table 300 of FIG. 3 and may contain information regarding signal interference from an input EM signal received by the communications circuitry and from other electronic device clocks. In certain embodiments, a processor can compare clock operating frequency data for multiple clocks. As an example, for a given set of EM signal data received by a processor, which may include frequency and/or signal strength data for the input EM signal received by communications circuitry, the processor can access stored lookup table entries for multiple clocks and compare results between clocks. As with lookup table 300 in FIG. 3, some data structures may include estimates of system and/or component noise levels or scores evaluating signal quality for a given clock setting. Clock settings, such as, for example, operating frequency and power levels, corresponding to higher scores can be selected to improve device performance.

In certain embodiments, different scores may correspond to different device parameters. For example, in certain embodiments, a given score may reflect noise levels at the communication circuitry while other scores may reflect device power consumption at different clock operating frequencies. Similarly, lookup tables may also include information regarding the “costs” of switching clock frequencies (e.g., higher power consumption, decreased battery life, device temperature increase, etc.) compared to the improvements in system performance and noise reduction.

At block 450, operating frequencies for the at least two clocks based on the received EM signal data and the accessed clock frequency lookup table data entries can be selected. In some embodiments, the selected operating frequency or frequencies can be selected to optimize system and performance requirements.

In block 460, instructions can be sent to one or more clocks to set clock operating frequencies. The clocks may include clock tuning circuitry similar to clock tuning circuitry 122 (FIG. 1), clock tuning circuitry A 245 (FIG. 2), or clock tuning circuitry B 255 (FIG. 2). In certain embodiments, only one clock frequency is adjusted. In other embodiments, multiple clock frequencies are adjusted. In certain embodiments, each clock has its own unique tuning circuitry, while in other embodiments, multiple clocks share the same tuning circuitry. After receiving instructions from the processor, clock tuning circuitry can adjust clock frequencies for one or more clocks as required by the instructions. Process 400 can then end at block 470.

In addition to or in lieu of adjusting clock frequencies to avoid interference, another embodiment of the invention can select either a high-side or low-side injection of the clock signal provided to the canless RF module. The clock signal (CS frequency) provided to the canless RF module (e.g., clock A from FIG. 2) can be one of two frequency components provided to a mixer. The other frequency component (RF frequency) can be RF frequency signal received by an antenna associated with the RF module. The mixer can be a frequency multiplier that produces an intermediate frequency (IF) output, which is the absolute value of (RF-CS). Thus, for any given RF frequency and IF frequency, there are two CS frequencies: one above a predetermined RF frequency the user wishes to tune to (i.e., high-side injection) and one below the predetermined RF frequency (i.e., low-side injection). If there is noise associated with the low-side CS frequency, the high-side CS frequency should be used, and vice versa.

A lookup table such as the one discussed above in connection with FIG. 3, or a separate lookup table, may specify whether the high-side or low-side injection of the clock signal provided to the RF module should be used for a predetermined RF signal the user wishes to tune to. For example, if a user wishes to tune to FM 101.3, the lookup table may be accessed to determine the appropriate clock frequency to be provided to the RF module for that FM station, and also determine whether to use the high-side or low-side of that clock frequency.

The above described embodiments of the disclosed systems and methods are presented for purposes of illustration and not of limitation. Further, it should be noted that the language used in the specification has been principally selected for readability and instructional purposes, and may not have been selected to delineate or circumscribe the disclosed subject matter. Accordingly, the disclosure of the presently disclosed subject matter is intended to be illustrative, but not limiting, of the scope of the claimed subject matter, which is set forth in the following claims.

What is claimed is:

1. An electronic device comprising:
a canless radio frequency (RF) module operative to tune to a plurality of RF frequencies;
a first clock operative to provide a first clock signal having either a first clock frequency or a second clock frequency to the canless RF module;
a second clock operative to provide a second clock signal having either a third clock frequency or a fourth clock frequency;
a processor in operative communication with the canless RF module, the first clock, and the second clock, the processor operative to:
determine the RF frequency that the canless RF module is tuned to;
access a clock frequency data structure to determine whether the first clock should provide the first clock signal having the first clock frequency or the second clock frequency and whether the second clock should provide the second clock signal having the third clock frequency or the fourth clock frequency based on the tuned to RF frequency;
instruct the first clock to operate at the first or second clock frequency based on the determination made in accessing the clock frequency data structure; and
instruct the second clock to operate at the third or fourth clock frequency based on the determination made when accessing the clock frequency data structure, wherein the first and second clocks operate at clock frequencies that substantially minimize interference with the tuned to RF frequency.

2. The electronic device of claim 1, wherein the canless RF module is operative to tune to frequencies selected from the group comprising FM frequencies, AM frequencies, cellular frequencies, and Wi-Fi frequencies.

3. The electronic device of claim 1, wherein the clock frequency data structure stores clock frequency data based on measurement results of an electronic device.

4. The electronic device of claim 1, wherein the clock frequency data structure stores clock frequency data based on electromagnetic simulation results of an electronic device.

5. The electronic device of claim 1, wherein the clock frequency data structure stores clock frequency data associated with more than two clocks.

6. The electronic device of claim 1, wherein the clock frequency data structure stores data associated with input signal bandwidth.

7. The electronic device of claim 1, wherein the clock frequency data structure stores data associated with input signal strength.

8. The electronic device of claim 1, wherein the clock frequency data structure stores data associated with input signal carrier frequency.

9. A method of adjusting clock frequency on an electronic device comprising:
receiving radio frequency (RF) signal data;
determining a RF frequency of a plurality of RF frequencies to tune a canless RF module based on the received RF signal data;
accessing a data structure storing clock frequency operating data for a first clock providing a first clock signal to the canless RF module and a second clock providing a second clock signal,
accessing data in the data structure associated with the determined RF frequency, the first clock, and the second clock;
determining whether the first clock should provide the first clock signal at a first clock frequency or a second clock frequency and whether the second clock should provide the second clock signal at a third clock frequency or a fourth clock frequency based on the accessed data using data accessed from the data structure;
instructing the first clock to operate at the first clock frequency or the second clock frequency; and
instructing the second clock to operate at the third clock frequency or the fourth clock frequency.

10. The method of claim 9, wherein determining whether the first clock should provide the first clock signal at the first clock frequency or the second clock frequency and whether the second clock should provide the second clock signal at the third clock frequency or the fourth clock frequency comprises comparing clock frequency operating data for the first clock with clock frequency operating data for the second clock.

11. The method of claim 10, wherein comparing clock frequency operating data for the first clock with clock frequency operating data for the second clock comprises comparing noise level data associated with different operating frequencies for each clock.

12. The method of claim 10, wherein comparing clock frequency operating data for the first clock with clock frequency operating data for the second clock comprises comparing power consumption data associated with different operating frequencies for each clock.

13. The method of claim 9, wherein the RF signal data is selected from the group comprising FM radio data, AM radio data, left channel spectrum data, and right channel spectrum data.

14. The method of claim 9, further comprising determining whether a third clock should provide a third clock signal at a fifth clock frequency or a sixth clock frequency.

15. The method of claim 9, wherein accessing data in the data structure associated with the determined RF frequency, the first clock, and the second clock comprises accessing multiple data entries associated with the first clock.

16. The method of claim 9, wherein accessing data in the data structure associated with the determined RF frequency, the first clock, and the second clock comprises accessing multiple data entries associated with the second clock.

17. The method of claim 9, wherein instructing the first clock to operate at the first clock frequency or the second clock frequency comprises instructing the first clock to operate at a frequency higher than the determined RF frequency of a plurality of RF frequencies to tune a canless RF module.

18. The method of claim 9, wherein instructing the first clock to operate at the first clock frequency or the second clock frequency comprises instructing the first clock to operate at a frequency lower than the determined RF frequency of a plurality of RF frequencies to tune a canless RF module
